(19) United States
(12) Patent Application Publication
(10) Pub. No.: US 2021/0256468 A1
(43) Pub. Date: Aug. 19, 2021

(54) METHODS AND SYSTEMS FOR IMPROVED MAIL DELIVERY AND NOTIFICATIONS

(71) Applicant: Capital One Services, LLC, McLean, VA (US)

(72) Inventor: Mary DOWNING, Richmond, VA (US)

(73) Assignee: Capital One Services, LLC, McLean, VA (US)

(21) Appl. No.: 16/794,434

(22) Filed: Feb. 19, 2020

(51) Int. Cl. G06Q 10/08; H04L 12/58

(52) U.S. Cl. CPC G06Q 10/0833; H04L 51/046; G06Q 10/0835

(57) ABSTRACT

A computer-implemented method for informing a recipient of a delivery may include obtaining a status identifier of the delivery from a third-party entity; obtaining delivery data of the delivery from the third-party entity based on the status identifier; determining identification data of the recipient of the delivery based on the status identifier; comparing the delivery data and the identification data of the recipient; determining a first delivery status of the delivery based on the comparison of the identification data and the delivery data via one or more algorithms; receiving sender feedback on the first delivery status from a sender of the delivery; determining a second delivery status based on the sender feedback; and transmitting, to the recipient, a notification based on the second delivery status.

### TECHNICAL FIELD

Various embodiments of the present disclosure relate generally to informing a recipient and/or sender of details for a delivery of a package or letter of interest, and, more particularly, to improving delivery efficacy, convenience, timing, and/or notifications by providing delivery details and opportunities to customize delivery timings to recipients and/or senders.

### BACKGROUND

Currently, third-party entities (e.g., postal service agencies) can inform customers or users of regular deliveries (e.g., via mail) scheduled to arrive at addresses associated with those customers or users. However, systems managing and distributing such information may include some limitations. For example, such systems may not inform the customers or users as to an exact time such deliveries are scheduled to arrive. Additionally, third-party entities (e.g., postal service agencies) may require individuals to sign up to receive information about all regular deliveries to an address; thus, customers and users may not receive notifications regarding deliveries of interest if they do not sign up to receive information about all deliveries. Further, third-party entities providing such services do not necessarily inform senders of regular deliveries.

The present disclosure is directed to overcoming one or more of these above-referenced challenges and/or limitations. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for informing a recipient of a delivery.

In an aspect, a computer-implemented method for informing a recipient of a delivery may include obtaining, via one or more processors, a status identifier of the delivery from a third-party entity, wherein the third-party entity includes a postal service agency; obtaining, via the one or more processors, delivery data of the delivery from the third-party entity based on the status identifier, wherein the delivery data includes at least one of an address or a delivery time of the delivery; determining, via the one or more processors, identification data of the recipient of the delivery based on the status identifier, wherein the identification data includes at least one of a name or an address of the recipient of the delivery; comparing, via the one or more processors, the delivery data and the identification data of the recipient; determining, via the one or more processors, a first delivery status of the delivery based on the comparison of the identification data and the delivery data via one or more algorithms; receiving, via the one or more processors, sender feedback on the first delivery status from a sender of the delivery, wherein the sender feedback includes altering the first delivery status; determining, via the one or more processors, a second delivery status based on the sender feedback; and transmitting, to the recipient, a notification based on the second delivery status.

In another aspect, a computer system for informing a recipient of a delivery may include a memory storing instructions; and one or more processors configured to execute the instructions to perform operations. The operations may include obtaining a status identifier of the delivery from a third-party entity, wherein the third-party entity includes a postal service agency; obtaining delivery data of the delivery from the third-party entity based on the status identifier, wherein the delivery data includes at least one of an address or a delivery time of the delivery; determining identification data of the recipient of the delivery based on the status identifier, wherein the identification data includes at least one of a name or an address of the recipient of the delivery; comparing the delivery data and the identification data of the delivery; determining a first delivery status of the delivery based on the comparison of the identification data and the delivery data via one or more algorithms; receiving, via the one or more processors, sender feedback on the first delivery status from a sender of the delivery, wherein the sender feedback includes altering the first delivery status; determining, via the one or more processors, a second delivery status based on the sender feedback; and transmitting, to the recipient, a notification based on the second delivery status.

In yet another aspect, a non-transitory computer readable medium for use on a computer system containing computer-executable programming instructions for performing a method of informing a recipient of a delivery. The method may include obtaining, via one or more processors, a status identifier of the delivery from a third-party entity, wherein the third-party entity includes a postal service agency; obtaining, via the one or more processors, delivery data of the delivery from the third-party entity based on the status identifier, wherein the delivery data includes at least one of an address or a delivery time of the delivery; determining, via the one or more processors, identification data of the recipient of the delivery based on the status identifier, wherein the identification data includes at least one of a name or an address of the recipient of the delivery; comparing, via the one or more processors, the delivery data and the identification data of the delivery; determining, via the one or more processors, a first delivery status of the delivery based on the comparison of the identification data and the delivery data via one or more algorithms; receiving, via the one or more processors, sender feedback on the first delivery status from a sender of the delivery, wherein the sender feedback includes altering the first delivery status; determining, via the one or more processors, a second delivery status based on the sender feedback; and transmitting, to the recipient, a notification based on the second delivery status.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure, according to one or more embodiments.

FIG. 2 depicts a flowchart of an exemplary method of informing a recipient of a delivery, according to one or more embodiments

FIG. 3 depicts a flowchart of another exemplary method of informing a recipient of a delivery, according to one or more embodiments.

FIG. 4 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In the following description, embodiments will be described with reference to the accompanying drawings. As will be discussed in more detail below, in various embodiments, data such as a status identifier, delivery data, identification data, a first delivery status, sender feedback, or a second delivery status may be used to inform a recipient or sender of a delivery of a particular package of interest, and/or to allow the recipient or sender to alter the delivery of the particular package of interest.

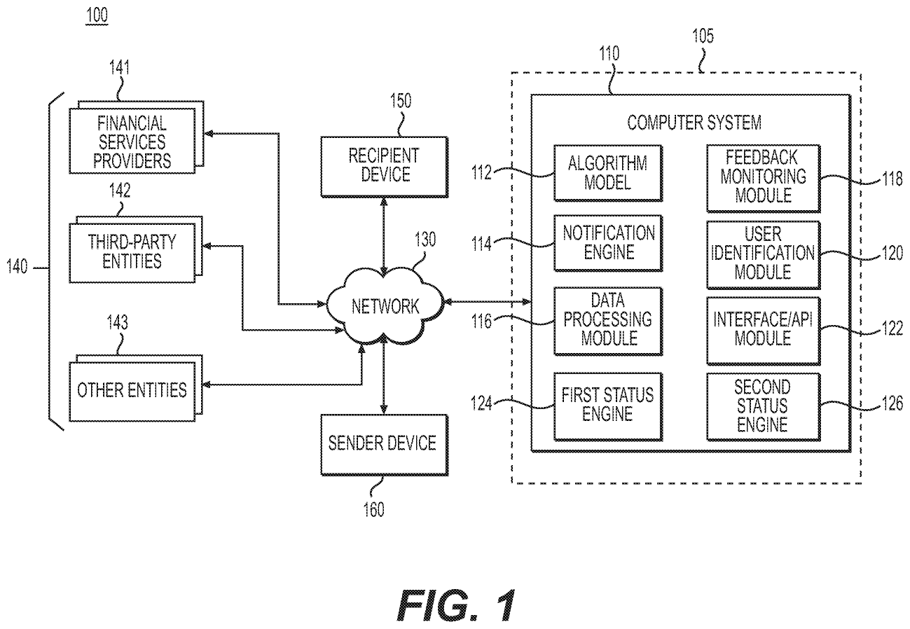

FIG. 1 is a diagram depicting an example of a system environment 100 according to one or more embodiments of the present disclosure. The system environment 100 may include a computer system 110, a network 130, one or more resources for collecting data (e.g., a status identifier, delivery data, or identification data) 140, a recipient device 150, and a sender device 160. The one or more resources for collecting data 140 may include the financial services providers 141, the third-party entities 142, and the other entities 143. These components may be in communication with one another via the network 130.

The computer system 110 may have one or more processors configured to perform methods described in this disclosure. The computer system 110 may include one or more modules, models, or engines. The one or more modules, models, or engines may include an algorithm model 112, a notification engine 114, a data processing module 116, a feedback monitoring module 118, a user identification module 120, an interface/API module 122, a first status engine 124, and/or a second status engine 126, which may each include hardware and/or software components stored in the computer system 110. The computer system 110 may be configured to utilize one or more modules, models, or engines when performing various methods described in this disclosure. In some examples, the computer system 110 may have a cloud computing platform with scalable resources for computation and/or data storage, and may run one or more applications on the cloud computing platform to perform various computer-implemented methods described in this disclosure. In some embodiments, some of the one or more modules, models, or engines may be combined to form fewer modules, models, or engines. In some embodiments, some of the one or more modules, models, or engines may be separated into separate, more numerous modules, models, or engines. In some embodiments, some of the one or more modules, models, or engines may be removed while others may be added.

The algorithm model 112 may include one or a plurality of algorithm models. The algorithm model 112 may include a machine learning model (e.g., a trained machine learning model). Details of the algorithm model 112 are described elsewhere herein. The notification engine 114 may be configured to generate and communicate (e.g., transmit) one or more notifications to the recipient device 150 or the sender device 160 through the network 130. The one or more notifications may be based on the first delivery status or second delivery status. The data processing module 116 may be configured to monitor, track, clean, process, or standardize data (e.g., status identifier, delivery data, or identification data) received by the computer system 110. One or more algorithms may be used to clean, process, or standardize the data. The feedback monitoring module 118 may be configured to monitor or track feedback (e.g., sender feedback) or any information of the sender or the recipient. The feedback monitoring module 118 may retrieve, store, and otherwise aggregate or manage current or historical feedback (e.g., sender feedback) information from the recipient device 150, the sender device 160, or the one or more resources 140. The user identification module 120 may manage identification data for each user (e.g., recipient or sender) accessing the computer system 110, possibly including, but not limited to, user names, passwords, contact information, social security numbers, or any additional information pertaining to each user accessing the computer system 110. The identification data may further include user preference information, demographic information, and other data related to a particular user. In one implementation, the identification data associated with each user may be stored to, and retrieved from, the one or more resources 140 or one or more components of a data storage associated with the computer system 110. The interface/API module 122 may allow the user to interact with one or more modules, models, or engines of the computer system 110. The first status engine 124 and/or the second status engine 126 may be configured to determine the first delivery status and/or the second delivery status, respectively. The first status engine 124 and/or the second status engine 126 may retrieve or gather data from the one or more resources 140, the recipient device 150, or the sender device 160, analyze such data, and transmit or report the data to other modules, models, or engines of the computer system 110.

The computer system 110 may be configured to receive data from other components (e.g., the one or more resources 140, the recipient device 150, and/or the sender device 160) of the system environment 100 through the network 130. The computer system 110 may further be configured to utilize the received data by inputting the received data into the algorithm model 112 to produce a result. Information indicating the result (e.g., second delivery status) may be transmitted to the recipient device 150 or the sender device 160 over the network 130. In some examples, the computer system 110 may be referred to as a server system that provides a service including providing the information indicating the result to the recipient device 150 or the sender device 160.

The network 130 may be any suitable network or combination of networks and may support any appropriate protocol suitable for communication of data to and from the computer system 110. The network 130 may include a public network (e.g., the Internet), a private network (e.g., a network within an organization), or a combination of public and/or private networks. The network 130 may include one or more networks that connect devices and/or components in the network layout to allow communication between the devices and/or components. For example, the network may be implemented as the Internet, a wireless network, a wired network (e.g., Ethernet), a local area network (LAN), a Wide Area Network (WANs), Bluetooth, Near Field Communication (NFC), or any other type of network that enables communication between one or more components of the network layout. In some embodiments, the network 130 may be implemented using cell and/or pager networks, satellite, licensed radio, or a combination of licensed and unlicensed radio.

The financial services providers 141 may include one or more entities such as a bank, credit card issuer, merchant services providers, or other type of financial service entity. In some examples, the financial services providers 141 may include one or more merchant services providers that provide the merchants 143 with the ability to accept electronic payments, such as payments using credit cards and debit cards. Therefore, the financial services providers 141 may collect and store credit information, identification data, transaction/purchasing information, and/or user instructions. The financial services providers 141 may be associated with one or more of the third-party entities 142, so the financial services providers 141 may retrieve or gather data from the third-party entities 142, and transmit or report the data to other modules, models, or engines of the computer system 110. Such association may be based on, e.g., a contractual relationship or partnership agreement.

The third-party entity 142 may include any entity handling delivery services. Such entity may include postal service agencies (e.g., the United States Postal Service), private package delivery companies (e.g., FedEx®, UPS®, DHL®, etc.), courier services, and the like. The third-party entity 142 may collect and store status identifier, delivery data, identification data, first delivery status, or second delivery status. The third-party entity 142 may be associated with the financial services providers 141, so the third-party entity 142 may retrieve or gather data from and transmit or report the data to other modules, models, or engines of the computer system 110.

The other entities 143 may include, e.g., online resources such as webpages, websites, e-mail, apps, or social network sites. Online resources may additionally or alternatively be provided by the financial services providers 141, manufacturers, or retailers (e.g., merchants). The online resources may include other computer systems, such as web servers, that are accessible by the computer system 110. The online resources may be configured to provide any information regarding a receipt or a sender.

The other entities 143 may also or alternatively include merchants, where each merchant is an entity that markets or sells one or more products. In this disclosure, the term “product,” in the context of products offered by a merchant, encompasses both goods and services, as well as products that are a combination of goods and services. In some embodiments, for example, the product may be a credit card. A merchant may be, for example, a vehicle dealer, a retailer, a grocery store, an entertainment venue, a service provider, a restaurant, a bar or other type of entity that provides products that a consumer or a user may consume. One or more of the other entities 143 may be associated with the third-party entities 142, so that the other entities 143 may retrieve or gather data from the third-party entities 142, and transmit or report the data to other modules, models, or engines of the computer system 110. Such association may be based on, e.g., a contractual relationship or partnership agreement.

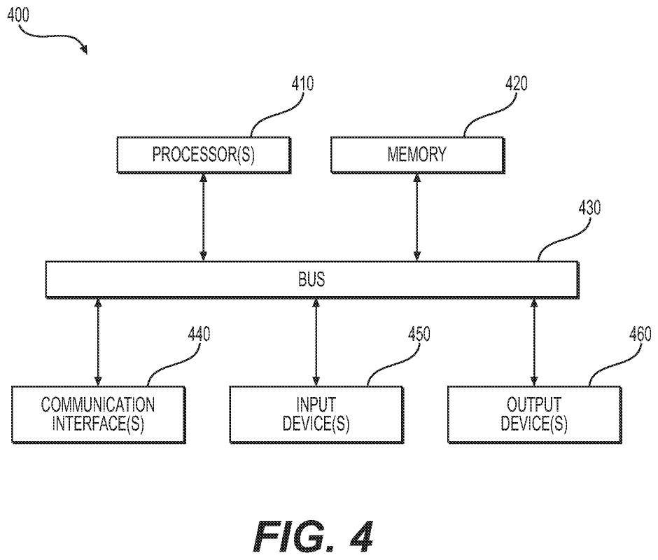

The financial services providers 141, the third-party entities 142, and the other entities 143 may each include one or more computer systems configured to gather, process, transmit, and/or receive data. In general, whenever any of the financial services providers 141, the third-party entities 142, and the other entities 143 is described as performing an operation of gathering, processing, transmitting, or receiving data, it is understood that such operation may be performed by a computer system thereof. In general, a computer system may include one or more computing devices, as described in connection with FIG. 4 below.

The recipient device 150 (i.e., a device associated with the recipient of a delivery, such as a delivery made by a third party entity 142) and/or the sender device 160 (i.e., a device associated with the sender of a delivery, such as a delivery made through a third party entity 142) may operate a client program, also referred to as a user application, used to communicate with the computer system 110. This user application may be used to provide information to the computer system 110 and to receive information from the computer system 110. The recipient device 150 and/or the sender device 160 may be associated with the interface/API module 122 of the computer system 110. In some examples, the user application may be a mobile application that is run on the recipient device 150 and/or the sender device 160. The recipient device 150 and/or the sender device 160 may be an electronic mobile device (e.g., smartphone, tablet, pager, personal digital assistant (PDA)), a computer (e.g., laptop computer, desktop computer, server), or a wearable device (e.g., a smartwatch). The recipient device 150 and/or the sender device 160 can also include any other device capable of providing or rendering data. The recipient device 150 and/or the sender device 160 may optionally be portable. The recipient device 150 and/or the sender device 160 may be handheld. The recipient device 150 and/or the sender device 160 may be a network device capable of connecting to a network, such as the network 130, or other networks such as a local area network (LAN), wide area network (WAN) such as the Internet, a telecommunications network, a data network, or any other type of network.

The recipient device 150 and/or the sender device 160 may be utilized to obtain feedback from a user (e.g., a recipient or sender of a delivery), obtain identification data of the user, and/or authenticate the user. Authenticating the user may include, e.g., obtaining identification data of the user and comparing such identification data with pre-stored identification data. During an authenticating process, one or more algorithms may be used to compare the identification data with pre-stored identification data and determine whether there is a match (e.g., a complete match or a match equal to or exceeding a predetermined threshold of similarity) between the identification data and pre-stored identification data. The user may be able to access the device (e.g., the recipient device 150 or the sender device 160) based on whether there is a match (e.g., a complete match or a match equal to or exceeding a predetermined threshold of similarity) between the identification data with pre-stored identification data. The pre-stored identification may be generated when a device (e.g., recipient device or sender device) is registered or connected with the one or more resources 140. In some embodiments, once the pre-stored identification has been generated, it may be stored with other user account information and/or authentication information.

The computer system 110 may be part of an entity 105, which may be any type of company, organization, or institution. In some examples, the entity 105 may be a financial services provider (e.g., the financial services provider 141). In such examples, the computer system 110 may have access to data pertaining to consumer transactions through a private network within the entity 105. For example, if the entity 105 is a card issuer, the entity 105 may collect and store identification data or credit information involving a credit card or debit card issued by the entity 105. In such examples, the computer system 110 may still receive identification data or credit information from other financial services providers 141. In another example, the computer system 110 may provide data pertaining to the delivery to the entity 105 via a relationship between the financial services providers 141 and the third-party entities 142. Such relationship may include a contractual relationship or a partnership agreement.

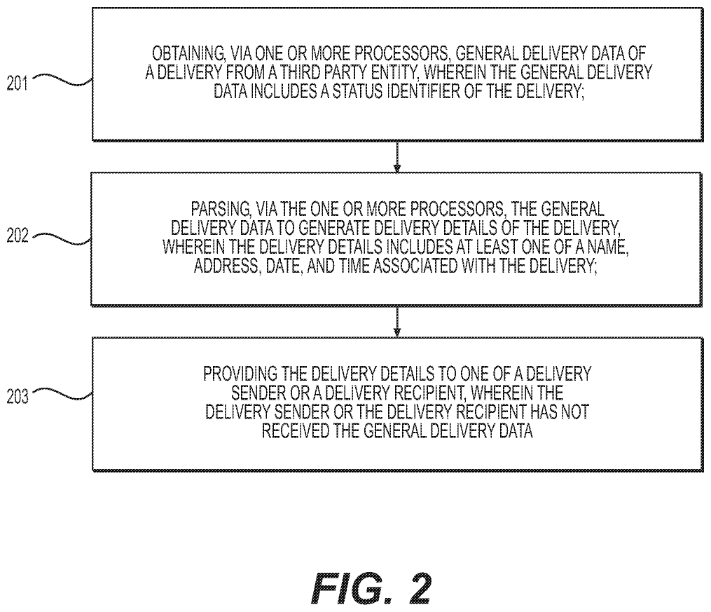

FIG. 2 is a flowchart illustrating a method for informing a recipient of a delivery, according to one or more embodiments of the present disclosure. The method may be performed in part or entirely by the computer system 110.

Step 201 may include obtaining, via one or more processors, general delivery data of a delivery being made by a third party entity. The general delivery data may include, e.g., a status identifier of the delivery. The general delivery data may additionally include or indicate any information regarding the delivery, the sender of the delivery, or the recipient of the delivery, including, an actual name, a username, passwords, contact information (e.g., address, phone numbers, e-mail addresses, etc.), a social security number, and/or additional information pertaining to a recipient or a sender. The additional information may include recipient or sender preference information (e.g., a preferred address to receive a delivery), demographic information (e.g., age, gender, marital status, income level, educational background, number of children in household, etc.), employment, and/or other data related to the recipient or the sender. As mentioned elsewhere herein, the third party entity may include a postal service agency. The general delivery data may be generated by, .e.g., a program, algorithm, or system run by the third party entity, such as a delivery notification program, algorithm, or system. Such a program, algorithm, or system may include systems and methods to scan or otherwise analyze deliveries, track deliveries, and compile various data regarding deliveries. The general delivery data may be stored in, e.g., one or more databases associated with the third party entity. In some embodiments, the entity 105 or the computer system 110 may obtain the general delivery data from the one or more databases associated with the third party entity. In such embodiments, the entity 105 may have a contractual relationship with the third party entity to obtain the general delivery data from the one or more databases. In one example, a user may sign up with an account on a website associated with a third party entity (e.g., a postal service agency), which can activate a feature to receive general delivery data. Such feature may send a notification (e.g., email) daily to the user about the general delivery data, such as, expected time of a delivery. The user may also select to receive the general delivery data from any entities that are partners with the third party entity (e.g., an entity which partners with a postal service agency via a contractual relationship). The general delivery data may or may not be transformed to delivery details, and may be transferred to and/or stored at any entities that are partners with the third party entity so that the entities can send a trigger-based notification (e.g., an email) to the user to alert the user of the incoming delivery. Via an entity partnering with the third party entity, the process of informing a user of a delivery can help mitigate fraud, provide detailed information, and boost confidence of the delivery process. Details of the status identifier and the third party entity are described elsewhere herein.

Step 202 may include parsing, via the one or more processors, the general delivery data to generate delivery details of the delivery. One or more algorithms may be used to parse the general delivery data to generate the delivery details. This step may be performed by, e.g., the computer system 110 or the one or more resources 140. Such algorithm(s) may translate or extract information indicated in the general delivery data to the delivery details. The delivery details may include any information that can be read and/or understood by a recipient or a sender associated with the delivery. The delivery details may include at least one of a name (e.g., either a name of a sender or a name of a recipient), an address, a date, and/or time associated with the delivery. The delivery details may also include any information provided in delivery data, a first delivery status, or a second delivery status, which are described elsewhere herein. In some embodiments, the step of parsing the general delivery data may include, e.g., removing extraneous information about a delivery that is not applicable to, e.g., a sender and/or recipient of a delivery. In some embodiments, the step of parsing the general delivery data may include, e.g., adding information about a delivery that is applicable to, e.g., a sender and/or recipient of a delivery. For example, in some embodiments, general delivery data may include more than one name associated with a recipient, or a name not associated with a recipient (e.g., a name of an individual or entity sharing an address with the recipient). Additionally or alternatively, the general delivery data may include information (e.g., identifying information, confidential information, preferences, etc.) associated with an individual or entity other than the recipient. Such data, in some embodiments, may be removed as a part of the step of parsing the general delivery data. In some embodiments, parsing the general delivery data may include standardizing and translating the general delivery data into general delivery details that can be understood by the recipient or the sender. For instance, the general delivery data may include abbreviated text indicating an address of the delivery, and the step of parsing the general delivery data may include translating the abbreviated text into a language that can be understood by a recipient or a sender.

Step 203 may include providing the delivery details to one of a delivery sender or a delivery recipient. In some embodiments, the delivery sender or delivery recipient may have not already received some or all of the general delivery data. In alternate embodiments, the delivery sender or delivery recipient may have received the general delivery data, but may not have received delivery details that were not included in the general delivery data. In one example, the delivery recipient may be one of a plurality of residents who lives at an address to which the delivery is intended to be made, and the general delivery data from the third-party entity may be sent to one resident other than the delivery recipient, such that the delivery recipient does not receive the general delivery data. In this situation, the method may enable the delivery recipient to receive the delivery details. In another example, the third party entity may not be able to send the general delivery data to the delivery sender or delivery recipient on a preferred schedule, such as in real-time. In this situation, the method may include obtaining the general delivery data from a third-party entity (according to step 201), generating delivery details (according to step 202), and sending such delivery details to the delivery sender or delivery recipient (according to step 203) before the third-party entity sends the general delivery data to the delivery sender or delivery recipient.

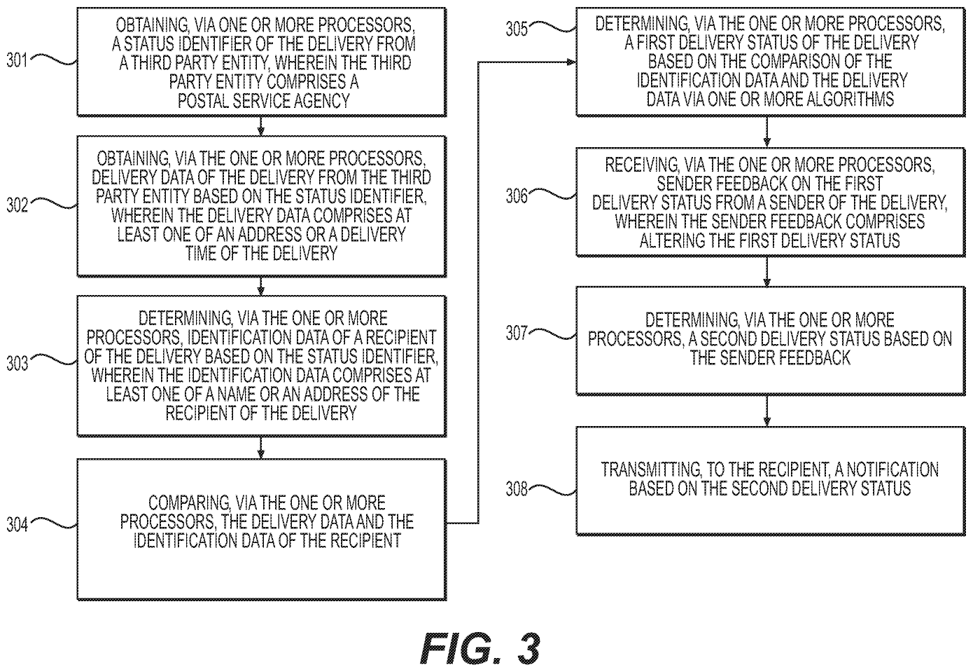

FIG. 3 is a flowchart illustrating a further method for informing a recipient of a delivery, according to one or more embodiments of the present disclosure. The method may be performed by some or all of the computer system 110.

Step 301 may include obtaining, via one or more processors, a status identifier of the delivery from a third-party entity. The third-party entity may include, e.g., a postal service agency, or any other third-party entity as described herein. The status identifier may include, e.g., a standard code or language that indicates a status of the delivery or any information regarding the delivery defined by the third-party entity. For example, the status identifier may include a number (e.g., a two-digit number) that indicates whether a delivery has been dispatched or arrived, and/or a number that indicates a timing, location, or other status of a delivery. In another example, the status identifier may include at least two letters that indicates a sender's address and/or a receiver's address of the delivery. In some embodiments, one or more algorithms may be used to interpret or translate the status identifier into another format so that other entities (e.g., other entities 143), financial services providers (e.g., financial service providers 141), recipients, or senders may be able to understand/interpret and carry out further procedures based on the status identifier.

The status identifier may also indicate any information regarding the delivery, including, but not limited to, information regarding the recipient or sender of the delivery (e.g., identification of the recipient or the sender), an image of a physical scan or photograph of the delivery at the third-party agency, an image of a physical scan or photograph of the delivery at the recipient's address, an undeliverable status of the delivery (e.g., the recipient is not at the recipient's address when the delivery is delivered), a notice indicating the delivery is oversized, a warning indicating the delivery is sent to a wrong address, a pick-up status (e.g., the delivery is available for picking up), a recall status (e.g., the sender recalls the delivery or the recall address is updated), a return status (e.g., the delivery is returned to the sender due to recipient's actions such as not picking it up), an electronic acceptance representing the delivery database generated by receipt/processing of the delivery, a status representing that an item is out for delivery, a status representing that the delivery is being sorted, a time when the delivery was dispatched from the sender's address, a when the delivery arrived at the third-party entity, the time when the delivery has been dispatched from the third-party entity (e.g., a postal service agency), or the recipient's address.

Step 302 may include obtaining, via the one or more processors, delivery data of the delivery from the third-party entity based on the status identifier. Such delivery data may be stored in one or more databases associated with the third-party entities. One or more algorithms may be used to interpret or translate the status identifier to generate or obtain the delivery data. Such interpretation or translation may include converting the status identifier into direct information regarding the delivery. For instance, the status identifier may include a number (e.g., a two-digit number) that indicates whether a delivery has been dispatched or arrived, and the converted direct information may include the indicated information by the number, such as “out for delivery,” “delivered,” or the like. In another example, the status identifier may include at least two letters in combination with one or more numbers (e.g., 11NWDC), and may indicate a recipient's address of the delivery, and the converted direct information a fully-recited recipient address (e.g., “1 First Street Northwest, District of Columbia.”)

In some embodiments, the delivery data may include at least one of an address or a delivery time of the delivery. The delivery data may further or alternatively include a description of contents of the delivery (e.g., what is or will be delivered to the recipient). The delivery data may include any information regarding the delivery, the sender of the delivery, and/or the recipient of the delivery. The delivery data may include any information that the recipient or the sender has provided to the third-party entity or that has otherwise been collected by the third-party entity, including, e.g., an actual name, a username, contact information (e.g., address, phone numbers, e-mail addresses, etc.), and/or additional information pertaining to the recipient or the sender. The additional information may include recipient or sender preference information, demographic information (e.g., age, gender, marital status, income level, educational background, number of children in household, etc.), employment, and/or other data related to the recipient or the sender. The delivery data may include any biometric data of the recipient or the sender. The biometric data may include, e.g., any information related to human characteristics of the recipient or the sender. The biometric data may additionally or alternatively include, e.g., physiological information such as a fingerprint, palm veins, face recognition, DNA, palm print, hand geometry, iris recognition, retina or odor/scent. The biometric data may also or alternatively include behavioral characteristics related to the pattern of behavior of the recipient or the sender, including but not limited to typing rhythm, gait, or voice.

Step 303 may include determining, via the one or more processors, identification data of the recipient of the delivery based on the status identifier. The step of determining identification data may include, e.g., obtaining the status identifier from the third-party entity, translating the status identifier to obtain the information regarding the recipient of the delivery via one or more processors associated with the financial services providers or other entities, and/or associating or mapping the information regarding the recipient of the delivery to the identification data stored with one or more databases associated with the financial services providers or other entities.

The identification data may include, e.g., at least one of a name or an address of the recipient of the delivery. In some embodiments, the identification data may be any type of information similar to the delivery data. The identification data may further or alternatively include an actual name, contact information (e.g., address, phone numbers, e-mail addresses, etc.), a social security number, and/or additional information pertaining to the recipient. The additional information may include, e.g., recipient preference information, demographic information (e.g., age, gender, marital status, income level, educational background, number of children in household, etc.), employment, and/or other data related to the recipient. The biometric data of the recipient may include any information related to human characteristics of the recipient. The biometric data may include, e.g., physiological information such as a fingerprint, palm veins, face recognition, DNA, palm print, hand geometry, iris recognition, retina or odor/scent. The biometric data may also or alternatively include behavioral characteristics related to the pattern of behavior of the recipient, including but not limited to typing rhythm, gait, or voice.

Step 304 may include comparing, via the one or more processors, the delivery data and the identification data of the recipient. The step of comparing the delivery data with the identification data may include matching the delivery data (e.g., delivery data stored in one or more databases associated with the third-party entities) with the identification data (e.g., identification data stored in one or more databases associated with the financial services providers or other entities). One or more algorithms may be used to compare the delivery data with the identification data and determine whether there is a match (e.g., a complete match or a match equal to or exceeding a predetermined threshold of similarity) between the delivery data with the identification data. If there is a match (e.g., a complete match or a match equal to or exceeding a predetermined threshold of similarity) between the delivery data with the identification data, first delivery status may be determined. For instance, the delivery data may include the address of the delivery stored in one or more databases associated with the third-party entities and the identification data may include the address of the recipient of the delivery stored in one or more databases associated with the financial services providers, and comparing the delivery data and the identification data may include comparing the address of the delivery and the address of the recipient of the delivery. In another example, the delivery data may include the name of the delivery stored in one or more databases associated with the third-party entities and the identification data may include the name of the recipient of the delivery stored in one or more databases associated with the financial services providers, and determining the first delivery status may include matching the name of the delivery to the name of the recipient of the delivery.

Step 305 may include determining, via the one or more processors, a first delivery status of the delivery based on the comparison of the identification data and the delivery data via one or more algorithms. The first delivery status may be determined based on whether there is a match (e.g., a complete match or a match equal to or exceeding a predetermined threshold of similarity) between the identification data and the delivery data. The first delivery status may include, e.g., whether the recipient is authorized to receive the delivery. If the identification data matches the delivery data, then the first delivery status may include that the recipient is authorized to receive the delivery, and may indicate any information about the delivery, the sender, or the recipient. The information about the delivery, the sender, or the recipient may include, identification data of the recipient or the sender (e.g., the recipient's name), delivery data (e.g., contents or a description of the delivery), an exact time when the delivery will be arrived at the recipient's address, and/or additional actions of the recipient in order to accept the delivery (e.g., providing a signature or paying delivery fee). For instance, in one example, a recipient may request an updated credit card to be sent by a financial services provider via a third-party entity. In this situation, the delivery data may include the name and address of the recipient stored in one or more databases associated with the third-party entity, and the identification data may include the name and address of the recipient stored in one or more databases associated with the financial services provider. If the name and address of the delivery data matches the name and address of identification data, then the first delivery status may indicate that recipient is authorized to receive the credit card. If the identification data does not match the delivery data, then the first delivery status may include that the recipient is not authorized to receive the delivery. The first delivery status may be transmitted to and/or shown on a device, such as the recipient device 150 or the sender device 160.

Step 306 may include receiving, via the one or more processors, sender feedback on the first delivery status from a sender of the delivery. The sender feedback may be provided by the sender of the delivery (e.g., to the computer system 110) via the sender device 160. The sender device 160 may display to the sender, e.g., the first delivery status and a request for sender feedback once the first delivery status is determined. The first delivery status and request for sender feedback may be displayed on the display screen or otherwise output in any suitable form, such as an e-mail, a text message, a push notification, content on a webpage, and/or any form of graphical user interface, and/or as audible output. The sender device 160 may be capable of accepting inputs of a sender via one or more interactive components of the sender device 160, such as a keyboard, button, mouse, touchscreen, touchpad, joystick, trackball, camera, microphone, or motion sensor. In some embodiments, the sender feedback may include altering the first delivery status. For instance, once the first delivery status is determined and that the recipient is authorized to receive the delivery, the sender may receive the first delivery status and a request, at the sender device 160, to confirm that the delivery can be delivered to the recipient. In this situation, the request may include any information regarding such delivery, including, but not limited to, the recipient's name, the recipient's address, the identification of contents of the delivery, or the time of the delivery. The sender may then provide sender feedback to confirm or deny the information regarding the delivery or adjust the information regarding the delivery. For instance, if the sender adjusts the information regarding the delivery, the sender may adjust the recipient's address or the time of the delivery. In some embodiments, the sender feedback may be determined by one or more algorithms (e.g., the algorithm 112), instead of the sender. In such embodiments, feedback may not be received from a sender, but rather may be received from a component of a computer system performing other steps of the method (e.g., the computer system 110). Such algorithms may include a trained machine learning algorithm. In such embodiments, the sender feedback may be inserted into the trained machine learning algorithm (e.g., a neural network) to update the trained machine learning algorithm.

Prior to step 306, or at any stage of informing a recipient of a delivery, the method may include receiving, via the one or more processors, recipient feedback on the first delivery status from a recipient of the delivery. The recipient feedback may be provided by the recipient of the delivery via the recipient device 150. The recipient device 150 may display the first delivery status and a request for recipient feedback once the first delivery status is determined. The first delivery status and request may be displayed on the display screen or otherwise output in any suitable form, such as an e-mail, a text message, a push notification, content on a webpage, and/or any form of graphical user interface, and/or as audible output. The recipient device 150 may be capable of accepting inputs of a recipient via one or more interactive components of the recipient device 150, such as a keyboard, button, mouse, touchscreen, touchpad, joystick, trackball, camera, microphone, or motion sensor. The recipient feedback may include altering the first delivery status. For instance, once the first delivery status is determined, the recipient may receive, on the recipient device 150, the first delivery status and a request to confirm information regarding the delivery before such information is sent to the sender. In this situation, the request may include any information regarding such delivery, including, but not limited to, the recipient's name, the recipient's address, the identification of contents of the delivery, and/or the time of the delivery. The recipient may then provide recipient feedback to adjust the information regarding the delivery. For instance, if the recipient adjusts the information regarding the delivery, the recipient may adjust the recipient's name regarding the delivery. The recipient feedback may be sent to the sender device so the sender feedback may be determined by the sender based on the first delivery status and/or the recipient feedback. Additionally, in some embodiments, the recipient feedback may be inserted into the trained machine learning algorithm (e.g., a neural network) to update the trained machine learning algorithm.

Step 307 may include determining, via the one or more processors, a second delivery status based on the sender feedback. The second delivery status may be determined based on sender feedback confirming, denying, or adjusting the first delivery status. The second delivery status may include any information about the delivery or the recipient, including, identification data of the recipient (e.g., the recipient's name), delivery data of the delivery (e.g., the identification of contents of the delivery), the exact time when the delivery will be arrived at the recipient's address, or additional actions of the recipient in order to accept the delivery (e.g., providing a signature or paying delivery fee). For instance, the first delivery status may include that recipient A is authorized to receive the delivery at 3 pm on a specific date, and the sender feedback may include confirming that the recipient A is authorized to receive the delivery and adjusting the delivery time to 8 pm on the specific date. Then the second delivery status may include that recipient A is authorized to receive the delivery at 8 pm on the specific date. In some embodiments, the computer system may communicate with the third party entity to adjust the delivery based on the second delivery status. For instance, the computer system 110 may formulate a request or instruction to deliver a package based on the second delivery status, and send that request to the third party entity (e.g., a postal service agency) so that the third party entity may adjust a delivery schedule to accommodate the second delivery status. The third party entity may also be able to communicate with the computer system 110 about any updates associated with the delivery. For instance, the third party entity may send a confirmation or a response to the computer system 110 regarding that the second delivery status has been accepted (e.g., a change of delivery schedule is accepted) or rejected (e.g., a change of delivery schedule is rejected due to limited delivery staff members).

Step 308 may include transmitting, to the recipient, a notification based on the second delivery status. The notification may demonstrate at least a sender feedback regarding the delivery. The notification may include an interactive element facilitating transmission of the notification to a person other than the recipient. For instance, upon receipt the notification, the recipient may be able to interact with the interactive element to transmit the notification to a friend or family member of the recipient so they can help with the delivery. In some embodiments, the notification may enable the recipient to provide additional recipient feedback based on the second delivery status. The additional recipient feedback may include altering the second delivery status. For instance, once the second delivery status is determined and a notification is transmitted to the recipient, the recipient may provide recipient feedback to adjust the information regarding the delivery, including, for instance, adjusting the recipient's address or the time of the delivery. Such additional recipient feedback may be inserted into the trained machine learning algorithm (e.g., a neural network) to update the trained machine learning algorithm.

Transmitting the notification may include transmitting the notification via any method or methods, including an e-mail, a text, a chat, a chime, a notification pop-up, a website, or a phone call. The notification may be displayed in a recipient interface. In some embodiments, the notification may be configured to be displayed on a display screen of a recipient device. The notification may be displayed on the display screen in any suitable form, such as an e-mail, a text message, a push notification, a banner, content on a webpage, and/or any form of graphical user interface. The recipient device 150 may be capable of accepting inputs of a recipient via one or more interactive components of the recipient device 150, such as a keyboard, button, mouse, touchscreen, touchpad, joystick, trackball, camera, microphone, or motion sensor.

The steps of determining the second delivery status and transmitting the notification may happen simultaneously or not simultaneously (e.g., sequentially). For instance, a period of time between determining the second delivery status (step 307) and transmitting the notification (step 308) may be at least 0.1 second, 0.5 second, 1 second, 5 seconds, 10 seconds, 30 seconds, 1 minute, or more. In some embodiments, a period of time between determining the second delivery status and transmitting the notification may be at most 1 minute, 30 seconds, 10 seconds, 5 seconds, 1 second, 0.1 second or less. In some embodiments, the period of time between determining the second delivery status and transmitting the notification may be determined by one or more algorithms, the sender, or the recipient. For instance, the sender feedback may include that a period of time between determining the second delivery status and transmitting the notification is 30 minutes. In this situation, after the second delivery status is determined, the recipient may need to wait for 30 minutes to receive the notification. In another example, the recipient feedback may include that a period of time between determining the second delivery status and transmitting the notification is less than 0.1 second. In this situation, after the second delivery status is determined, the recipient may receive the notification immediately.

After transmitting the notification to the recipient, or at any stage of informing a recipient of a delivery, the method may include enabling the recipient to communicate with the third-party entity regarding the second delivery status of the delivery. Such communication may be done via the recipient's interaction with the interactive element displayed on a display of the recipient device. The communication may include updated identification data of the recipient (e.g., an updated recipient's address) or updated delivery data of the delivery (e.g., a preferred time of the delivery). For instance, once the notification is transmitted to the recipient, the recipient may read the notification and communicate with the third-party entity to deliver all the deliveries of the recipient to a new address.

The recipient may be one of a plurality of residents registered as residing at the address of the delivery. As an example, there may be three people living at a specific address that is scheduled to receive a delivery, and the recipient of the delivery is one of the three people. In this situation, the delivery data stored in one or more databases associated with third-party entities may indicate the specific address of the delivery and names of all the three people living at the specific address (or one person living at the specific address), and the identification data stored in one or more databases associated with financial services providers may indicate the specific address of the delivery, the identification of contents of the delivery, and the name of the recipient of the delivery. Thus, the notification may only be sent to the recipient instead of other two people living at the specific address.

In some embodiments, The one or more algorithms may include, e.g., a trained machine learning algorithm. The trained machine learning algorithm may be used to determine sender feedback or recipient feedback. The trained machine learning algorithm may include a regression-based model that accepts the status identifier, delivery data, identification data, first delivery status, or second delivery status as input data. The trained machine learning algorithm may be part of the algorithm model 112. The trained machine learning algorithm may be of any suitable form, and may include, for example, a neural network. A neural network may be software representing a human neural system (e.g., cognitive system). A neural network may include a series of layers termed “neurons” or “nodes.” A neural network may comprise an input layer, to which data is presented, one or more internal layers, and an output layer. The number of neurons in each layer may be related to the complexity of a problem to be solved. Input neurons may receive data being presented and then transmit the data to the first internal layer through the connections' weight. The trained machine learning algorithm may include a convolutional neural network (CNN), a deep neural network, a recurrent neural network (RNN), or any other type of neural network.

The trained machine learning algorithm may compute sender feedback or recipient feedback as a function of the status identifier, identification data, first delivery status, second delivery status, or one or more variables indicated in the input data. The one or more variables may be derived from the status identifier, identification data, first delivery status, or second delivery status. This function may be learned by training the machine learning algorithm with training sets.

The machine learning algorithm may be trained by supervised, unsupervised, or semi-supervised learning using training sets comprising data of types similar to the type of data used as the model input. For example, the training set used to train the model may include any combination of the following: status identifier of a delivery to the recipient, delivery data of the delivery to the recipient, identification data of the recipient, first delivery status of the delivery to the recipient, second delivery status of the delivery to the recipient, status identifier of deliveries associated with people other than the recipient, delivery data of deliveries associated with people other than the recipient, identification data of deliveries associated with people other than the recipient, first delivery status of deliveries associated with people other than the recipient, second delivery status of deliveries associated with people other than the recipient, or any other data. Accordingly, the machine learning model may be trained to map input variables to a quantity or value of sender feedback or recipient feedback. That is, the machine learning model may be trained to determine a quantity or value of sender feedback or recipient feedback as a function of various input variables.

In general, any process discussed in this disclosure that is understood to be computer-implementable, such as the processes illustrated in FIGS. 2-3, may be performed by one or more processors of a computer system, such as the computer system 110, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable type of processing unit.

A computer system, such as the computer system 110, the recipient device 150, and/or the sender device 160, may include one or more computing devices. If the one or more processors of the computer system 110, the recipient device 150, and/or the sender device 160 are implemented as a plurality of processors, the plurality of processors may be included in a single computing device or distributed among a plurality of computing devices. If a computer system 110, the recipient device 150, and/or the sender device 160 includes a plurality of computing devices, the memory of the computer system 110, the recipient device 150, and/or the sender device 160 may include the respective memory of each computing device of the plurality of computing devices.

FIG. 4 illustrates an example of a computing device 400 of a computer system, such as the computer system 110, the recipient device 150, and/or the sender device 160. The computing device 400 may include processor(s) 410 (e.g., CPU, GPU, or other such processing unit(s)), a memory 420, and communication interface(s) 440 (e.g., a network interface) to communicate with other devices. Memory 420 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 420. The computing device 400 may, in some embodiments, further include input device(s) 450 (e.g., a keyboard, mouse, or touchscreen) and output device(s) 460 (e.g., a display, printer). The aforementioned elements of the computing device 400 may be connected to one another through a bus 430, which represents one or more buses. In some embodiments, the processor(s) 410 of the computing device 400 includes both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be repeated, added to, or deleted from methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

What is claimed is:

1. A computer-implemented method for informing a recipient of a delivery, the method comprising:
obtaining, via one or more processors, a status identifier of the delivery from a third party entity, wherein the third party entity comprises a postal service agency;
obtaining, via the one or more processors, delivery data of the delivery from the third party entity based on the status identifier, wherein the delivery data comprises at least one of an address or a delivery time of the delivery;
determining, via the one or more processors, identification data of the recipient of the delivery based on the status identifier, wherein the identification data comprises at least one of a name or an address of the recipient of the delivery;
comparing, via the one or more processors, the delivery data and the identification data of the recipient;
determining, via the one or more processors, a first delivery status of the delivery based on the comparison of the identification data and the delivery data via one or more algorithms;
receiving, via the one or more processors, sender feedback on the first delivery status from a sender of the delivery, wherein the sender feedback comprises altering the first delivery status;
determining, via the one or more processors, a second delivery status based on the sender feedback; and
transmitting, to the recipient, a notification based on the second delivery status.

2. The computer-implemented method of claim 1, wherein the delivery data further includes identification of contents of the delivery.

3. The computer-implemented method of claim 2, wherein the notification demonstrates at least one of the delivery time or the identification of contents of the delivery.

4. The computer-implemented method of claim 1, further including enabling, after transmitting the notification to the recipient, the recipient to communicate with the third party entity regarding the second delivery status of the delivery.

5. The computer-implemented method of claim 1, wherein the delivery data includes the address of the delivery and the identification data includes the address of the recipient of the delivery, wherein comparing the delivery data and the identification data includes comparing the address of the delivery and the address of the recipient of the delivery.

6. The computer-implemented method of claim 5, wherein the identification data includes the name of the recipient of the delivery, wherein determining the first delivery status includes matching the address of the delivery to the name of the recipient of the delivery.

7. The computer-implemented method of claim 1, wherein a period between determining the second delivery status and transmitting the notification is at most 1 minute.

8. The computer-implemented method of claim 1, wherein the recipient is one of a plurality of residents registered as residing at the address of the delivery.

9. The computer-implemented method of claim 1, wherein the notification includes an interactive element facilitating transmission of the notification to a person other than the recipient.

10. The computer-implemented method of claim 1, wherein transmitting the notification includes transmitting the notification via an e-mail.

11. A computer system for informing a recipient of a delivery, comprising:
a memory storing instructions; and
one or more processors configured to execute the instructions to perform operations including:
obtaining a status identifier of the delivery from a third party entity, wherein the third party entity comprises a postal service agency;
obtaining delivery data of the delivery from the third party entity based on the status identifier, wherein the delivery data comprises at least one of an address or a delivery time of the delivery;
determining identification data of the recipient of the delivery based on the status identifier, wherein the identification data comprises at least one of a name or an address of the recipient of the delivery;
comparing the delivery data and the identification data of the delivery;
determining a first delivery status of the delivery based on the comparison of the identification data and the delivery data via one or more algorithms;
receiving, via the one or more processors, sender feedback on the first delivery status from a sender of the delivery, wherein the sender feedback comprises altering the first delivery status;
determining, via the one or more processors, a second delivery status based on the sender feedback; and
transmitting, to the recipient, a notification based on the second delivery status.

12. The computer system of claim 11, wherein the delivery data further includes identification of contents of the delivery.

13. The computer system of claim 12, wherein the notification demonstrates at least one of the delivery time or the identification of contents of the delivery.

14. The computer system of claim 11, further including enabling, after transmitting the notification to the recipient, the recipient to communicate with the third party entity regarding the second delivery status of the delivery.

15. The computer system of claim 11, wherein the delivery data includes the address of the delivery and the identification data includes the address of the recipient of the delivery, wherein comparing the delivery data and the identification data includes comparing the address of the delivery and the address of the recipient of the delivery.

16. The computer system of claim 15, wherein the identification data includes the name of the recipient of the delivery, wherein determining the first delivery status includes matching the address of the delivery to the name of the recipient of the delivery.

17. The computer system of claim 11, wherein the recipient is one of a plurality of residents registered as residing at the address of the delivery.

18. The computer system of claim 11, wherein a period between determining the second delivery status and transmitting the notification is at most 1 minute.

19. The computer system of claim 11, wherein transmitting the notification includes transmitting the notification via an e-mail.

20. A non-transitory computer readable medium for use on a computer system containing computer-executable programming instructions for performing a method of informing a recipient of a delivery, the method comprising:
obtaining, via one or more processors, a status identifier of the delivery from a third party entity, wherein the third party entity comprises a postal service agency;
obtaining, via the one or more processors, delivery data of the delivery from the third party entity based on the status identifier, wherein the delivery data comprises at least one of an address or a delivery time of the delivery;
determining, via the one or more processors, identification data of the recipient of the delivery based on the status identifier, wherein the identification data comprises at least one of a name or an address of the recipient of the delivery;
comparing, via the one or more processors, the delivery data and the identification data of the delivery;
determining, via the one or more processors, a first delivery status of the delivery based on the comparison of the identification data and the delivery data via one or more algorithms;
receiving, via the one or more processors, sender feedback on the first delivery status from a sender of the delivery, wherein the sender feedback comprises altering the first delivery status;
determining, via the one or more processors, a second delivery status based on the sender feedback; and
transmitting, to the recipient, a notification based on the second delivery status.
